(19) United States
(12) Patent Application Publication
(10) Pub. No.: US 2009/0036182 A1
(43) Pub. Date: Feb. 5, 2009

(54) Sliding mechanism and electronic device using the same and case sliding method

(75) Inventor: Chun-Yang Chen, SuZhou City (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/219,153

(22) Filed: Jul. 17, 2008

(30) Foreign Application Priority Data
Aug. 2, 2007 (TW) 96128471

(51) Int. Cl. H04M 1/02

(52) U.S. Cl. 455/575.4

(57) ABSTRACT

A sliding mechanism including a sliding case, a main body and a driving assembly is provided. The sliding case sliding on the main body between a first position and a second position has a movement confine assembly including a first bump. The main body has an initiating assembly including a button, a first fastener for engaging with the first bump, and a start key. The button and the start key are disposed at one side of the main body. The driving assembly to which the start key is electrically connected is disposed between the sliding case and the main body. When the button is pressed as the sliding case locates in the first position, the button pushes the first fastener to detach the first fastener from the first bump. The button further pushes the start key to activate the driving assembly for moving the sliding case towards the second position.

This application claims the benefit of Taiwan application Serial No. 96128471, filed Aug. 2, 2007, the subject matter of which is incorporated herein by reference.

### BACKGROUND OF THE INVENTION

1. Field of the Invention

The invention relates in general to a sliding mechanism and electronic device using the same and case siding method, and more particularly to a sliding mechanism which slides automatically and electronic device using the same and case sliding method.

2. Description of the Related Art

In recent years, mobile phones have gained a great popularity and can be seen everywhere. In order to satisfy various needs of consumers, mobile phones keep developing new functions, such as photo taking or music playing. Further, in addition to the developing of new functions, mobile phones have also been provided with various appearance types, such as bar type, slide type or clamshell type, for consumers to choose from. Among these different types, due to the advantageous features such as small volume and large screen size, the slide type mobile phones have increasingly drawn favor from consumers, and the market share of the slide type mobile phones has been raised year by year. Therefore, more and more slide type mobile phones are thus developed and provided to meet the preference of concumers.

In one slide type mobile phone commonly seen in the market, a display screen and several function keys are disposed on the sliding case, and other elements such as number keypad and battery are disposed on the main body. Normally, user can operate part of the functions of the mobile phone simply via the function keys disposed on the sliding case. As for dialing numbers or texting messages, user needs to slide away the sliding case to expose the keypad on the main body to perform said functions. Earlier slide type mobile phones require user to manually slide the sliding case to a post-slide position, largely reducing the convenience of use. In recent years, a semiautomatic slide type of mobile phones is provided. Typically, in a semiautomatic slide type mobile phone, one or more springs are applied to provide the force for moving the sliding case. However, such semiautomatic slide type mobile phone still requires user to manually apply a force to push the sliding case for a short distance, so that the springs are deformed and store a potential. After the sliding case is kept pushing for a certain distance, the springs then convert their potential into kinetic energy which moves and ejects the sliding case with a certain acceleration. As the sliding case is ejected to the post-slide position, the sliding case will hit the main body and stop abruptly. Stopping the sliding case by way of hitting the sliding case with the main body not only makes sound but also deteriorates the stability and comfortness of holding the mobile phone. Worse than that, the mobile phone may come off from user's hand if the hitting force is too strong. Further, frequent hits may cause the elements of the mobile phone to become loose or damaged, largely reducing the durability of the mobile phone.

### SUMMARY OF THE INVENTION

The invention is directed to a sliding mechanism and an electronic device using the same and a case sliding method. The driving assembly, which is activated when a button is pressed, steadily drives the sliding case to move, hence preventing the sliding case from hitting the main body after moving to a fixed position. The hitting noise is then evitable, the lifespan of the parts can be prolonged, and durability of the product is largely increased.

According to a first aspect of the present invention, a sliding mechanism including a sliding case, a main body and a driving assembly is provided. The sliding case sliding on the main body between a first position and a second position has a movement confine assembly including a first bump. The main body has an initiating assembly including a button, a first fastener and a start key. The button and the start key are disposed at one side of the main body. The first fastener is for engaging with the first bump. The driving assembly to which the start key is electrically connected is disposed between the sliding case and the main body for driving the sliding case to move on the main body. When the button is pressed as the sliding case is located in the first position, the button pushes the first fastener so that the first fastener is detached from the first bump. The button further simultaneously pushes the start key to activate the driving assembly for moving the sliding case towards the second position.

According to a second aspect of the present invention, an electronic device including a main body, a sliding case and a sliding mechanism is provided. The sliding case slides on the main body between a first position and a second position. The sliding mechanism includes a movement confine assembly, an initiating assembly and a driving assembly. The movement confine assembly located on the sliding case includes a first bump. The initiating assembly disposed on the main body includes a button, a first fastener and a start key. The button and the start key are disposed at one side of the main body. The first fastener is for engaging with the first bump. The driving assembly to which the start key is electrically connected is disposed between the sliding case and the main body for driving the sliding case to move on the main body. When the button is pressed as the sliding case is located in the first position, the button pushes the first fastener so that the first fastener is detached from the first bump. The button further simultaneously pushes the start key to activate the driving assembly for moving the sliding case towards the second position.

According to a third aspect of the present invention, a case sliding method for driving a sliding case of an electronic device to move on a main body of the electronic device is provided. The sliding case slides on the main body between a first position and a second position. Firstly, a sliding mechanism including the sliding case, the main body and a driving assembly disposed between the sliding case and the main body is provided. The main body has a button disposed at one side of the main body. Next, the button is pressed. After that, the driving assembly moves the sliding case towards the second position from the first position. Then, when the sliding case is located in the second position, the driving assembly is stopped.

The invention will become apparent from the following detailed description of the preferred but non-limiting embodiment. The following description is made with reference to the accompanying drawings.

### BRIEF DESCRIPTION OF THE DRAWINGS

FIG. 1A shows an explosion diagram of an electronic device according to the preferred embodiment of the invention;

FIG. 1B shows a back side view of a sliding case in FIG. 1A;

FIG. 2 shows an electricity block diagram of the electronic device of FIG. 1A;

FIG. 3A shows a partial enlargement in which the electronic device corresponds to the first fastener;

FIG. 3B shows the button in FIG. 2A being pressed; and

FIGS. 4A˜4C shows the sliding case moving from the first position to the second position.

### DETAILED DESCRIPTION OF THE INVENTION

According to a sliding mechanism and an electronic device using the same and a case sliding method disclosed in the preferred embodiment of the invention, when the button of the electronic device is pressed, the first fastener is detached from the first bump and the driving assembly is activated in the meantime to move the sliding case from the first position to the second position. Thus, the automatic case-sliding can be achieved. The invention is exemplified below in a preferred embodiment. However, the present embodiment of the invention is only for elaboration but not for limiting the scope of the invention. Moreover, unnecessary elements are omitted in the accompanying drawings to highlight the technical features of the invention.

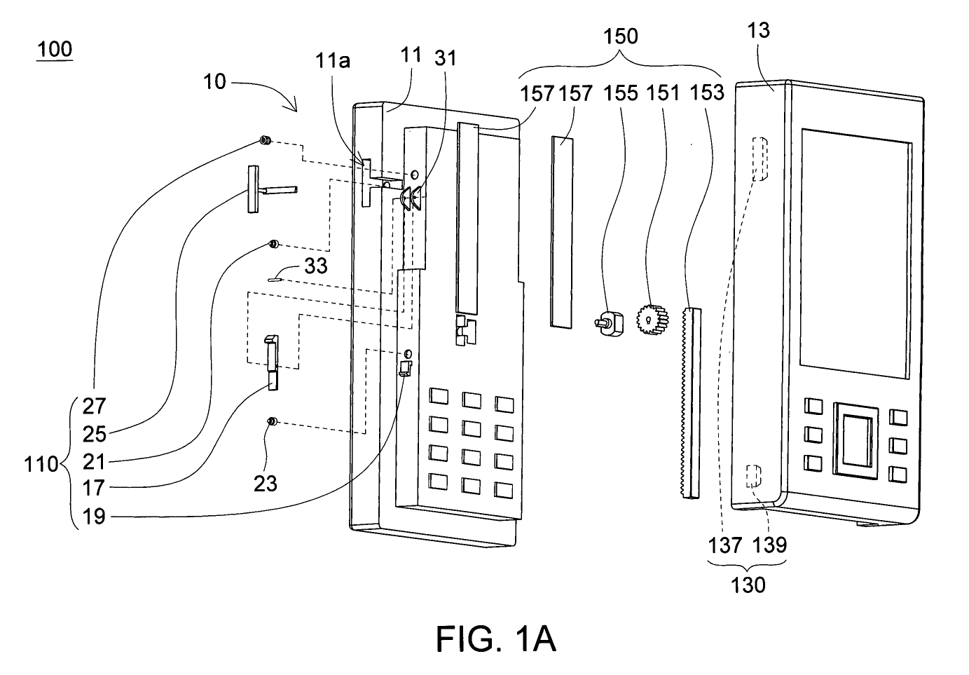

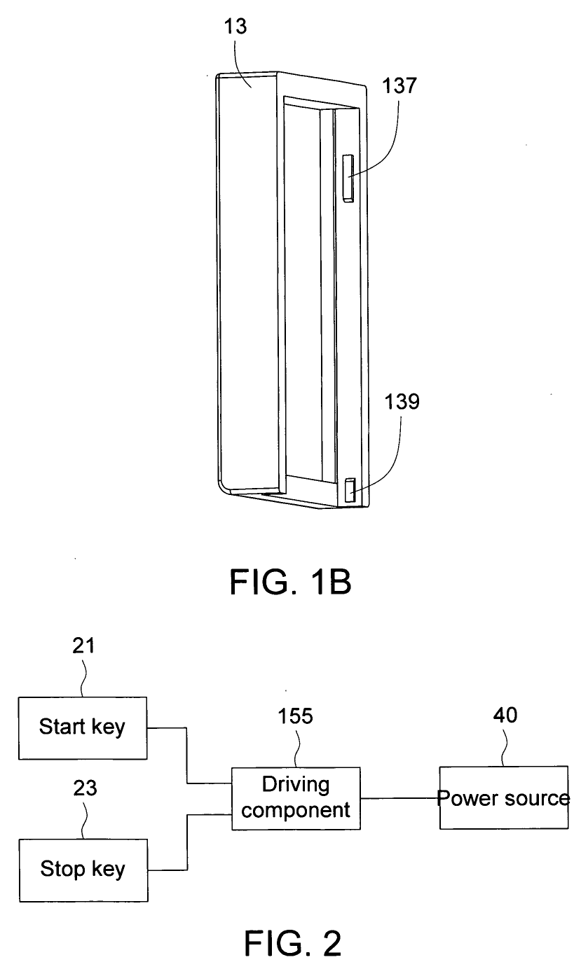

Referring to both FIG. 1A and FIG. 1B. FIG. 1A is an explosion diagram of an electronic device according to the preferred embodiment of the invention. FIG. 1B is a back side view of a sliding case in FIG. 1A. In the present embodiment, the electronic device 100 mainly includes a main body 11, a sliding case 13 and a sliding mechanism 10. The sliding case 13 slides on the main body 11 between a first position and a second position. The sliding mechanism 10 includes a movement confine assembly 130, an initiating assembly 110 and a driving assembly 150. The movement confine assembly 130 disposed on the sliding case 13 includes a first bump 137. The initiating assembly 110 disposed on the main body 11 includes a button 25, a first fastener 17 and a start key 21. The button 25 and the start key 21 are disposed at the same side of the main body 11. The first fastener 17 is for engaging with the first bump 137. The driving assembly 150 is disposed between the sliding case 13 and the main body 11 for driving the sliding case 13 to move on the main body 11. The start key 21 is electrically connected to the driving assembly 150. When the button 25 is pressed as the sliding case 13 is located in the first position, the button 25 pushes the first fastener 17 so that the first fastener 17 is detached from the first bump 137. The button 25 further simultaneously pushes the start key 21 to activate the driving assembly 150 for moving the sliding case 13 towards the second position.

More specifically, the movement confine assembly 130 further includes a second bump 139; and the initiating assembly 110 further includes a second fastener 19 for engaging with the second bump 139. In the present embodiment, both the first fastener 17 and a second fastener 19 are disposed on the main body 11; both the first bump 137 and the second bump 139 are disposed on the sliding case 13. When the first fastener 17 is engaged with the first bump 137, the sliding case 13 is fixed in the first position. When the second fastener 19 is engaged with the second bump 139, the sliding case 13 is fixed in the second position. Besides, the driving assembly 150 mainly includes a gear 151, a rack 153 and a driving component 155. The grear 151 is engaged with the rack 153 and is disposed on the main body 11 for example. The rack 153 is formed on the sliding case 13 through an in-mold decoration (IMD) method for example. Please refer to FIG. 2, an electricity block diagram of the electronic device of FIG. 1A is illustrated. The driving component 155 is electrically connected to a power source 40 of the electronic device 100. The start key 21 is electrically connected to the driving component 155 that is a micro-motor for example. When the start key 21 is pressed, the motor is activated and then starts to rotate. The gear 151 is connected to the driving component 155 and rotates synchronously with the driving component 155. While the driving component 155 drives the gear 151 rotating, the rack 153 moves with respect to the gear 151, so that the sliding case 13 moves with respect to the main body 11. Moreover, the driving assembly 150 can further includes at least one slide track 157. In the present embodiment, the driving assembly 150 preferably includes two slide tracks 157 that are respectively disposed at two sides of a surface of the main body 11. The sliding case 13 is movably connected to the main body 11 via the slide track 157. The slide track 157 can be formed on the main body 11 through the IMD method, and is preferably made from metal. While the driving assembly 150 drives the sliding case 13, the sliding case 13 moves along the slide track 157 with respect to the main body 11, so that the sliding case 13 can move smoothly in a fixed direction.

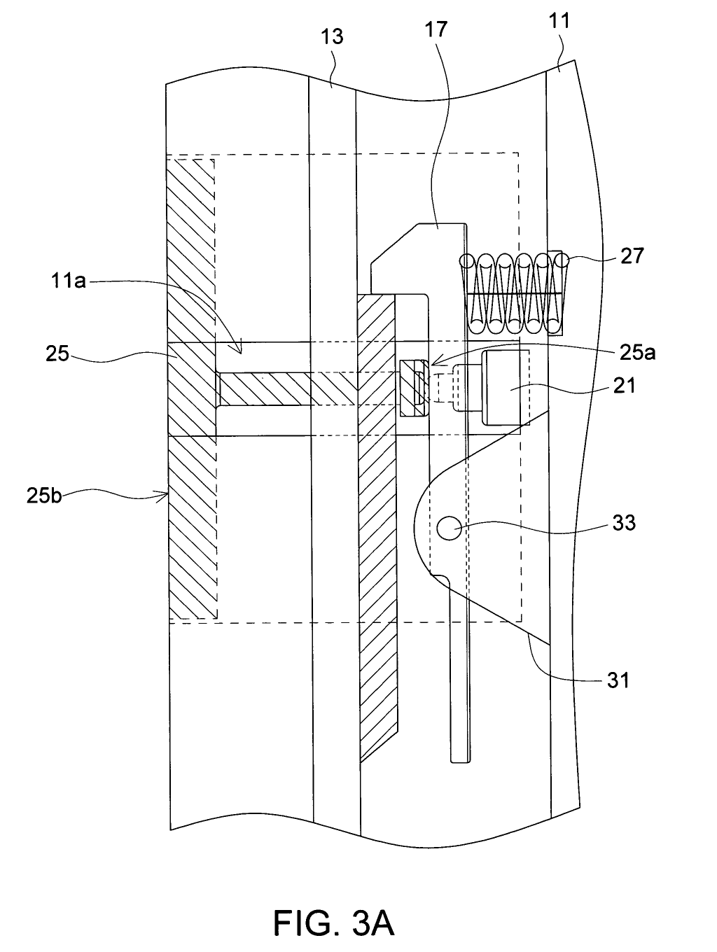

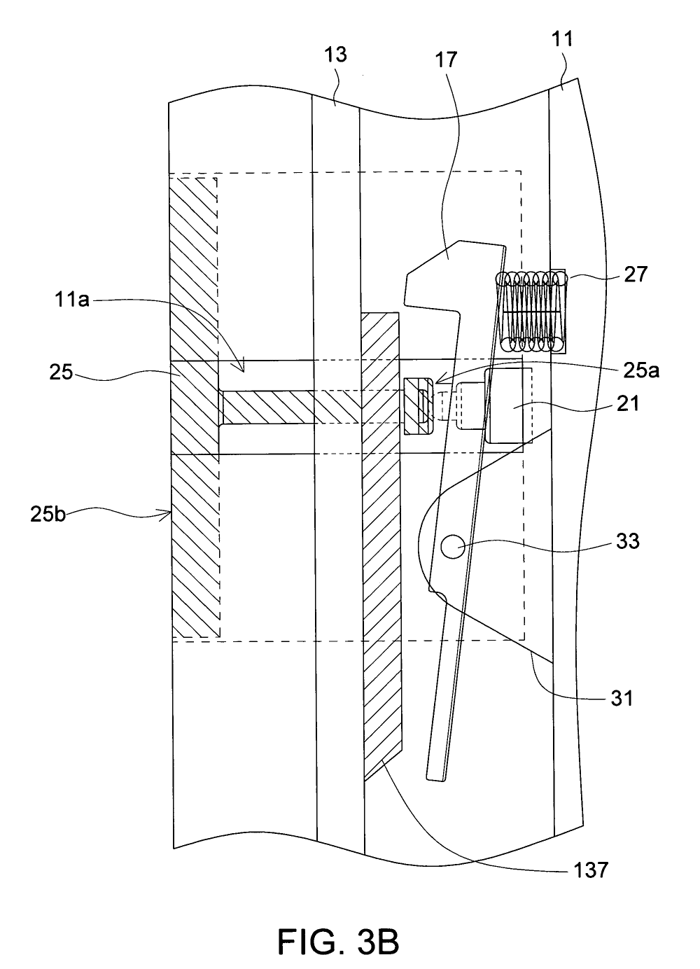

Besides, the sliding mechanism 10 further includes a stop key 23 electrically connected to the driving assembly 150 as indicated in FIG. 2. When the sliding case 13 moves to the second position with respect to the main body 11, the second bump 139 pushes the stop key 23 to stop the driving assembly 150. Moreover, the initiating assembly 110 includes an elastic element 27 whose two ends respectively press against the main body 11 and the first fastener 17. The elastic element 27 provides a restoring force to the first fastener 17. As the sliding case 13 locats in the first position, the restoring force pushes the first fastener 17 to engage with the first bump 137. Referring to FIG. 3A, a partial enlargement in which the electronic device corresponds to the first fastener is illustrated. The main body 11 has a button slot 11a in which the button 25 is disposed. The button 25 has a first side 25a and a second side 25b. The second side 25b is exposed outside the main body 11, and the first side 25a contacts the first fastener 17 and the start key 21 concurrently. Referring to FIG. 3B, the button in FIG. 2A being pressed is illustrated. When the button 25 is pressed, the first side 25a simultaneously presses the first fastener 17 and the start key 21. When the button 25 is pressed, the first fastener 17 that is engaged with the first bump 137 is detached from the first bump 137. Meanwhile, when the start key 21 is pressed, the driving assembly 150 (illustrated in FIG. 1A) is activated to move the sliding case 13. The stop key 23 is electrically connected to the driving assembly 150, more specifically, to the driving component 155 (as shown in FIG. 2). When the sliding case 13 moves to the second position, the second bump 139 contacts against and presses the stop key 23 to stop the driving assembly 150. On the other hand, the elastic element 27 can be exemplified by a spiral spring whose two ends respectively press against the main body 11 and the first fastener 17 to provide a restoring force to the first fastener 17 so that the first fastener 17 can be engaged with the first bump 137. Further, the first fastener 17 is disposed on the main body 11 by way of pivotally connecting to a holder 31 via a pivot 33. When the first fastener 17 is pressed by the first side 25a of the button 25 or pushed by the elastic element 27, the first fastener 17 can pivot on the holder 31 with respect to the main body 11 to be detached from or engaged with the first bump 137 repeatedly. In the electronic device 100 of the present embodiment, the first fastener 17, the second fastener 19, the start key 21, the stop key 23, the button 25, and the elastic element 27 are all disposed at the same side of the main body 11.

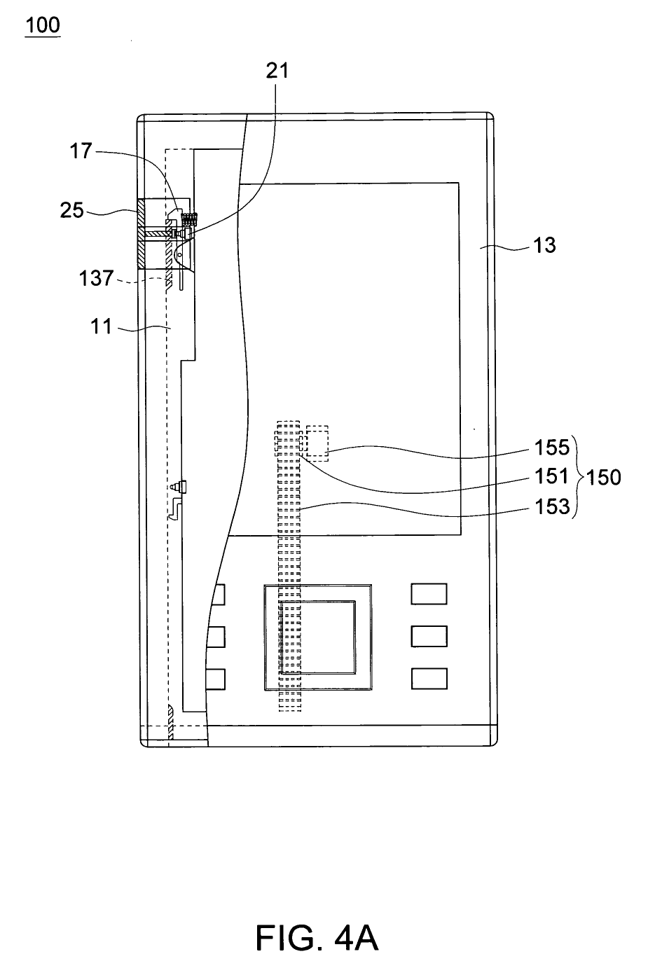

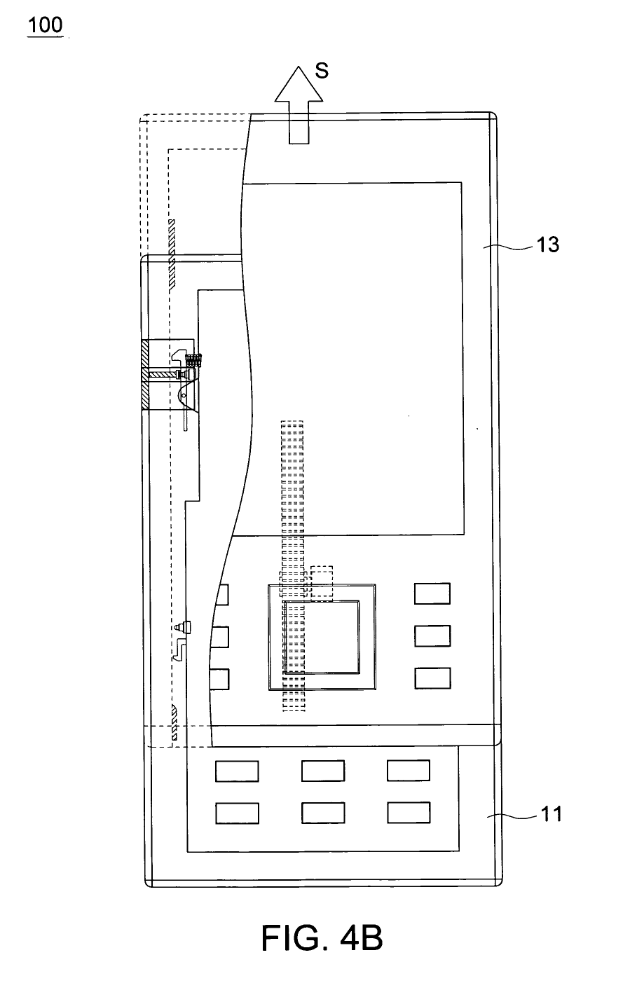

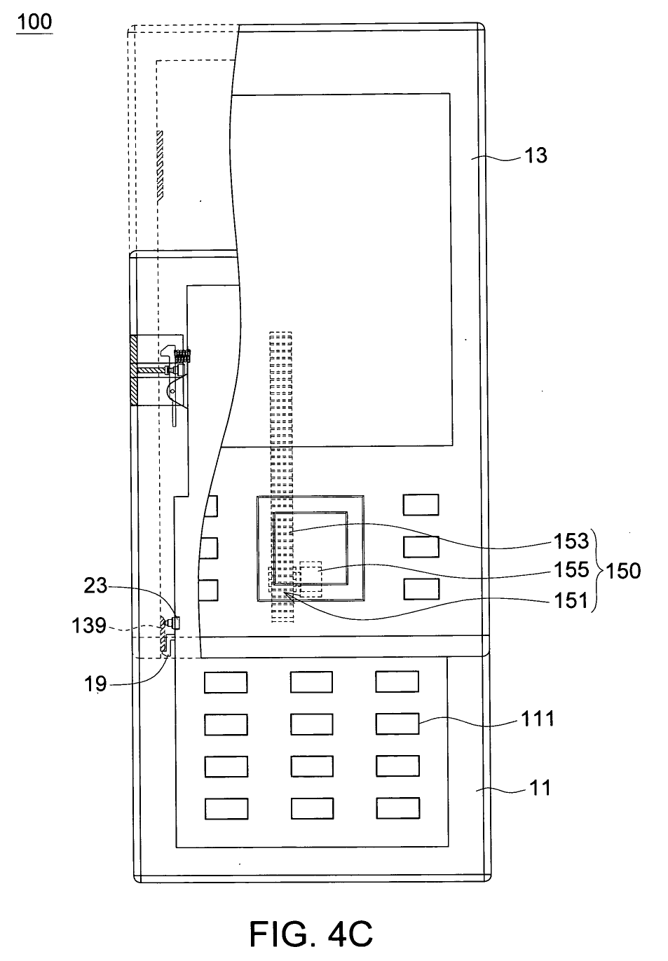

The manner that the sliding case 13 travels on the main body 11 between the first and the second positions is elaborated below. The electronic device 100 of the present embodiment is exemplified by a slide type mobile phone, and the first fastener 17 and the second fastener 19 are hooks for example. Referring to FIG. 4A˜4C, which respectively show the sliding case moving from the first position to the second position. First, as the sliding case 13 locats in the first position, the sliding case 13 is substantially stacked on the main body 11 as indicated in FIG. 4A, and the first fastener 17 is engaged with the first bump 137 of the sliding case 13. When the user presses the button 25, the first side 25a of the button 25 simultaneously presses the first fastener 17 and the start key 21 so that the first fastener 17 is detached from the first bump 137 as indicated in FIG. 3B.

At the same time, the start key 21 is pressed to activate the driving component 155. The driving component 155 drives the gear 151 to rotate so that the rack 153 moves with respect to the gear 151, and the sliding case 13 moves along a sliding direction S towards the second position as indicated in FIG. 4B.

When the sliding case 13 moves to the second position, as indicated in FIG. 4C, the second bump 139 of the sliding case 13 presses the stop key 23 to stop the driving assembly 150. Concurrently, the second fastener 19 is engaged with the second bump 139 to fix the sliding case 13 in the second position. Then, the case sliding method of the present embodiment is finished. As shown in FIG. 4C, the electronic device 100 exposes the keypad 111 on the main body 11 for user to operate with.

On the other hand, the method for moving the sliding case 13 back to the first position is elaborated below. First, a force is applied to the sliding case 13 along an opposite direction of the sliding direction S. Due to the stress applied to the second fastener 19, the second fastener 19 is detached from the second bump 139. Then, the force is continuously applied to the sliding case 13 along an opposite direction of the sliding direction S for moving the sliding case 13 back to the first position, which is the position of the sliding case 13 in FIG. 4A. When the sliding case 13 locats in the first position, the restoring force provided to the first fastener 17 by the elastic element 27 pushes the first fastener 17 to be engaged with the first bump 137 so as to fix the sliding case 13 in the first position.

In the above-described electronic device 100 of the present embodiment, although the first fastener 17 and the second fastener 19 are exemplified by hooks, the technology of the invention is not limited thereto. Other structures that can be cooperative with the first bump 137 and the second bump 139 for fixing the sliding case 13 lie within the scope of the invention. Moreover, in the present embodiment, the gear 151 and the driving component 155 are disposed on the main body 11, and the rack 153 is disposed on the sliding case 13 in the present embodiment, and the sliding case 13 is moved through the relatively movement of the rack 153 to the gear 151 which is driven by the driving component 155. However, the gear 151 and the driving component 155 can also be disposed on the sliding case 13, and the rack 153 can also be disposed on the main body 11. Besides that, the number of the slide track 157 is not limited. The driving assembly 150 can also have more than two slide tracks 157. In addition to that, other designs that can joint the sliding case 13 with the main body 11 and enable smoothly slide of the sliding case 13 on the main body are applicable to the invention. Although the electronic device 100 of the present embodiment is exemplified by a slide type mobile phone, the electronic device 100 can also be a personal digital assistant (PDA), an ultra mobile personal computer (UMPC) or other electronic device with case-sliding function.

In the present embodiment of the invention, the sliding mechanism 10 is applied in the electronic device 100. However, in another embodiment, the sliding case and the main body can be incorporated as a part of the sliding mechanism. That is, the sliding mechanism can include a sliding case, a main body and a driving assembly. The movement confine assembly and the initiating assembly are respectively disposed on the sliding case and the main body. Any other technologies using the initiating assembly to activate the driving assembly to move the sliding case and using the movement confine assembly to stop the driving assembly so as to achieve the effect of automatic case-sliding lies within the scope of the invention.

According to the sliding mechanism and the electronic device using the same and the case sliding method disclosed in the above-described preferred embodiment of the invention, the driving assembly disposed between the sliding case and the main body drives the sliding case to move on the main body. When the user presses the button, the driving component drives the gear, so that the rack moves with respect to the gear, and that the sliding case correspondingly moves with respect to the main body, hence enabling the electronic device to achieve the effect of automatic case-sliding. In the electronic device, the driving component, such as a micro-motor, drives the sliding case to move, so that the sliding case moves smoothly at a constant speed when moving from the first position to the second position. Moreover, the driving component stops driving the sliding case once the sliding case moves to the second position. As a result, the sliding case is prevented from collision with the main body after moving to a fixed position, not only making the electronic device more stable and comfortable when held in user's hand but also decreasing the likelihood of having loose or damaged parts. Therefore, the lifespan of the electronic device is prolonged. Furthermore, the sliding case can be securely fixed in the first and the second positions through the engagements of the first fastener with the first bump and the second fastener with the second bump respectively. Therefore, the sliding case will not sway or tilt on the main body, and the product quality is improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sliding mechanism, comprising:
a sliding case having a movement confine assembly, wherein the movement confine assembly comprises:
a first bump;
a main body on which the sliding case is slided between a first position and a second position, the main body having an initiating assembly, wherein the initiating assembly comprises:
a button disposed at one side of the main body;
a first fastener for engaging with the first bump; and
a start key disposed at the side of the main body; and
a driving assembly electrically connected to the start key and disposed between the sliding case and the main body for driving the sliding case to move on the main body;
wherein, when the button is pressed as the sliding case is located in the first position, the button pushes the first fastener to detach the first fastener from the first bump, and the button further simultaneously pushes the start key to activate the driving assembly for moving the sliding case towards the second position.

2. The sliding mechanism according to claim 1, wherein the driving assembly comprises:
a gear disposed on the main body;
a rack disposed on the sliding case and engaged with the gear; and
a driving component electrically connected to a power source of the electronic device for driving the gear to rotate;
wherein, when the driving component drives the gear to rotate, and the rack moves relatively to the gear so that the sliding case moves relatively to the main body.

3. The sliding mechanism according to claim 2, wherein the driving component is a micro-motor.

4. The sliding mechanism according to claim 2, wherein the driving assembly further comprises:
at least one slide track disposed on the main body, wherein the sliding case moves along the slide track relatively to the main body.

5. The sliding mechanism according to claim 2, wherein the start key is electrically connected to the driving component.

6. The sliding mechanism according to claim 1, wherein the movement confine assembly further comprises a second bump, and the initiating assembly further comprises a second fastener for engaging with the second bump.

7. The sliding mechanism according to claim 6, wherein the main body further comprises:
a stop key electrically connected to the driving assembly, wherein when the sliding case substantially moves to the second position relatively to the main body, the second bump pushes the stop key to stop the driving assembly.

8. The sliding mechanism according to claim 6, wherein when the sliding case moves to the second position, the second fastener is engaged with the second bump.

9. The sliding mechanism according to claim 1, wherein the initiating assembly further comprises:
an elastic element whose two ends respectively press against the main body and the first fastener, wherein the elastic element provides a restoring force to the first fastener for pushing the first fastener to be engaged with the first bump as the sliding case is located in the first position.

10. An electronic device, comprising:
a main body;
a sliding case sliding on the main body between a first position and a second position; and
a sliding mechanism, comprising:
a movement confine assembly disposed on the sliding case, wherein the movement confine assembly comprises:
a first bump; and
an initiating assembly disposed on the main body, wherein the initiating assembly comprises:
a button disposed at one side of the main body;
a first fastener for engaging with the first bump; and
a start key at the side of the main body; and
a driving assembly electrically connected to the start key and disposed between the sliding case and the main body for driving the sliding case to move on the main body;
wherein, when the button is pressed as the sliding case is located in the first position, the button pushes the first fastener to detach the first fastener from the first bump, and the button further simultaneously pushes the start key to activate the driving assembly for moving the sliding case towards the second position.

11. The electronic device according to claim 10, wherein the driving assembly comprises:
a gear disposed on the main body;
a rack disposed on the sliding case and engaged with the gear; and
a driving component electrically connected to a power source of the electronic device for driving the gear to rotate;
wherein, as the driving component drives the gear to rotate, and the rack moves relatively to the gear so that the sliding case moves relatively to the main body.

12. The electronic device according to claim 11, wherein the driving component is a micro-motor.

13. The electronic device according to claim 11, wherein the driving assembly further comprises:
at least one slide track disposed on the main body, wherein the sliding case moves along the slide track relatively to the main body.

14. The electronic device according to claim 11, wherein the start key is electrically connected to the driving component.

15. The electronic device according to claim 10, wherein the movement confine assembly further comprises a second bump, and the initiating assembly further comprises a second fastener for engaging with the second bump.

16. The electronic device according to claim 15, wherein the sliding mechanism further comprises:
a stop key electrically connected to the driving assembly, wherein when the sliding case substantially moves to the second position relatively to the main body, the second bump pushes the stop key to stop the driving assembly.

17. The electronic device according to claim 15, wherein when the sliding case moves to the second position, the second fastener is engaged with the second bump.

18. The electronic device according to claim 10, wherein the initiating assembly further comprises:
an elastic element whose two ends respectively press against the main body and the first fastener, wherein the elastic element provides a restoring force to the first fastener for pushing the first fastener to be engaged with the first bump as the sliding case is located in the first position.

19. A case sliding method, comprising:
providing a sliding mechanism comprising a sliding case, a main body and a driving assembly, wherein the sliding case slides on the main body between a first position and a second position, the driving assembly is disposed between the sliding case and the main body, and the main body has a button disposed at one side of the main body;
pressing the button;
driving the sliding case to move towards the second position from the first position by the driving assembly; and
stopping the driving assembly when the sliding case substantially moves to the second position.

20. The case sliding method according to claim 19, wherein in the step of providing the sliding mechanism, the main body further comprises a first fastener engaged with a first bump of the sliding case and a start key electrically connected to the driving assembly, the button has a first side contacting with the first fastener and the start key, and the step of pressing the button further comprises:
pressing the first fastener by the first side to detach the first fastener from the first bump; and
pressing the start key by the first side to activate the driving assembly.

21. The case sliding method according to claim 20, wherein the step of pressing the first fastener and the step of pressing the start key are performed 5 simultaneously.

22. The case sliding method according to claim 20, wherein the driving assembly comprises a driving component electrically connected to the start key, and the driving component is activated as the start key is pressed by the first side.

23. The case sliding method according to claim 22, wherein the driving assembly further comprises a gear disposed on the main body and a rack engaging with the gear disposed on the sliding case, and in the step of driving the sliding case, as the driving component drives the gear to rotate, the rack moves relatively to the gear so that the sliding case moves with respect to the main body.

24. The case sliding method according to claim 19, wherein the driving assembly further comprises at least one slide track, and in the step of driving the sliding case, the sliding case moves along the slide track relatively to the main body.

25. The case sliding method according to claim 19, wherein the main body further comprises a stop key electrically connected to the driving assembly, and in the step of stopping the driving assembly, a second bump of the sliding case presses the stop key to stop the driving assembly.

26. The case sliding method according to claim 25, wherein the main body further comprises a second fastener, and when the sliding case is located in the second position, the second bump is engaged with the second fastener.
